(19) United States
(12) Patent Application Publication
(10) Pub. No.: US 2025/0088387 A1
(43) Pub. Date: Mar. 13, 2025

(54) DYNAMIC CONNECTIONS (DYCON) INTERNET PROTOCOL (IP) VIRTUAL PRIVATE NETWORK (VPN) FUNCTIONALITIES

(71) Applicant: CenturyLink Intellectual Property LLC, Denver, CO (US)

(72) Inventors: Wen Wang, Ballwin, MO (US); Boris Abramovich, Maple Grove, MN (US); Syed Hussain Haider, South Elgin, IL (US)

(73) Assignee: CenturyLink Intellectual Property LLC, Denver, CO (US)

(21) Appl. No.: 18/824,051

(22) Filed: Sep. 4, 2024

Related U.S. Application Data
(60) Provisional application No. 63/581,826, filed on Sep. 11, 2023.

(51) Int. Cl. H04L 12/46; H04L 12/66; H04L 67/51

(52) U.S. Cl. CPC H04L 12/4641; H04L 12/66; H04L 67/51

(57) ABSTRACT

Novel tools and techniques are provided for implementing DyCon IPVPN functionalities. In various embodiments, a DyCon IPVPN system includes a gateway device, a plurality of orchestrators, and a plurality of task managers. The gateway device is configured to request an orchestrator from an orchestrator factory based on data contained in a request to perform a network provisioning service; and to instruct the orchestrator to perform the network provisioning service. The orchestrator is configured to request a task manager from a task factory based on a task type associated with a first task among one or more DyCon IPVPN tasks associated with the network provisioning service; and to instruct the task manager to perform the first task. The task manager is configured to perform at least one of creating the first task, triggering execution of the first task, or updating the first task, and/or the like.

### CROSS-REFERENCE TO RELATED APPLICATIONS

This application claims the benefit of U.S. Provisional Application No. 63/581,826 filed Sep. 11, 2023, entitled “Dynamic Connections (DYCON) Internet Protocol (IP) Virtual Private Network (VPN) Functionalities,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing provisioning of network services, and, more particularly, to methods, systems, and apparatuses for implementing dynamic connections (“DyCon”) Internet Protocol (“IP”) virtual private network (“VPN”) functionalities.

### BACKGROUND

Provisioning network services (such as IPVPN services) typically requires service providers to engage in various processes, some of which are performed manually. In some implementations, sequences of tasks for some networks services are determined on a case-by-case basis. Such conventional implementations are inefficient and, in some cases, time consuming. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

FIG. 1 depicts an example system for implementing dynamic connections (“DyCon”) Internet Protocol (“IP”) virtual private network (“VPN”) functionalities, in accordance with various embodiments.

FIG. 2A depicts an example sequence flow for implementing an example DyCon IPVPN build process, in accordance with various embodiments.

FIG. 2B depicts an example sequence flow for implementing an example DyCon IPVPN build process, in accordance with various embodiments.

FIG. 2C depicts an example sequence flow for implementing an example DyCon IPVPN cloud provisioning process, in accordance with various embodiments.

FIGS. 3A-3C depict various example sequence flows for implementing DyCon IPVPN functionalities, in accordance with various embodiments.

FIGS. 4A and 4B depict various example methods for implementing DyCon IPVPN functionalities, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing provisioning of network services, and, more particularly, to methods, systems, and apparatuses for implementing dynamic connections (“DyCon”) Internet Protocol (“IP”) virtual private network (“VPN”) functionalities.

In various embodiments, a DyCon IPVPN system includes a gateway device, a plurality of orchestrators, and a plurality of task managers. The gateway device is configured to request a first orchestrator among the plurality of orchestrators from an orchestrator factory based on data contained in a request to perform a first network provisioning service among a plurality of network provisioning services; and instruct the first orchestrator to perform the first network provisioning service. Each orchestrator of the plurality of orchestrators is configured to request a first task manager among the plurality of task managers from a task factory based on a task type associated with a first task among one or more DyCon IPVPN tasks associated with the first network provisioning service; and instruct the first task manager to perform the first task. Each task manager of the plurality of task managers is configured to perform at least one of: creating the first task; triggering execution of the first task; or updating the first task; and/or the like.

Merely by way of example, in some cases, the one or more DyCon IPVPN tasks include at least one of one or more virtual routing and forwarding (“VRF”) tasks; one or more network as a service (“NaaS”) IPVPN tasks; one or more NaaS API framework for queue management (“FQM”) tasks; one or more layer 3 VPN tasks; one or more layer 3 VPN API FQM tasks; one or more billing tasks; one or more billing API FQM tasks; or one or more inventory tasks; and/or the like. In some instances, the one or more VRF tasks include at least one of building a VRF instance; deleting a VRF instance; or updating a VRF instance; and/or the like. In some cases, the one or more NaaS IPVPN tasks include at least one of building a NaaS IPVPN network; deleting a NaaS IPVPN network; or updating a NaaS IPVPN network; and/or the like. In some examples, the one or more NaaS API FQM tasks include at least one of creating a NaaS API FQM; or deleting a NaaS API FQM; and/or the like. In examples, the one or more layer 3 VPN tasks include at least one of building a layer 3 VPN network; deleting a layer 3 VPN network; or updating a layer 3 VPN network; and/or the like. In some instances, the one or more layer 3 VPN API FQM tasks includes at least one of creating a layer 3 VPN API FQM; or deleting a layer 3 VPN API FQM; and/or the like. In some cases, the one or more billing tasks include at least one of building a billing record; deleting a billing record; or updating a billing record; and/or. In some examples, the one or more billing API FQM tasks include at least one of creating a billing API FQM; or deleting a billing API FQM; and/or the like. In examples, the one or more inventory tasks include at least one of updating a network resource inventory; or auditing a network resource inventory; and/or the like.

In some embodiments, each task manager is further configured to perform at least one of handling one or more task failures associated with implementing the first task; requesting a first NaaS service system among a plurality of NaaS service systems from a NaaS API factory based on a first resource type associated with the first task; or instructing the first NaaS service system to perform one of building a NaaS API associated with the first NaaS service system; deleting a NaaS API associated with the first NaaS service system: or obtaining a status of building or deleting a NaaS API associated with the first NaaS service system; and/or the like. In some cases, the plurality of NaaS service systems includes at least one a NaaS IP service system, a NaaS virtual private cloud (“VPC”) service system, a NaaS IPVPN network service system, or a NaaS layer 3 VPN service system, and/or the like. In some instances, triggering execution of the first task includes instructing, via the NaaS API, a downstream system to execute the first task.

The DyCon IPVPN implementation as described herein provide a workflow-oriented application in which a series of tasks are determined and the system implements building, deleting, updating, and/or handling failure conditions of tasks in the determined series of tasks to build or delete a network product or service (e.g., IPVPN, bare metal, or cloud provider product or service). In some cases, APIs are used for the DyCon IPVPN implementations. In this manner, automated and efficient dynamic connections may be achieved for provisioning the network services to the user(s). These and other aspects of the DyCon IPVPN functionalities are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In an aspect, the technology relates to a dynamic connections (“DyCon”) Internet Protocol virtual private network (“IPVPN”) system, including a gateway device, a plurality of orchestrators, and a plurality of task managers. The gateway device is configured to request a first orchestrator among the plurality of orchestrators from an orchestrator factory based on data contained in a request to perform a first network provisioning service among a plurality of network provisioning services; and instruct the first orchestrator to perform the first network provisioning service. Each orchestrator of the plurality of orchestrators is configured to request a first task manager among the plurality of task managers from a task factory based on a task type associated with a first task among one or more DyCon IPVPN tasks associated with the first network provisioning service; and instruct the first task manager to perform the first task. Each task manager of the plurality of task managers is configured to perform at least one of: creating the first task; triggering execution of the first task; or updating the first task; and/or the like.

In some embodiments, the data contained in the request includes a first product type among a plurality of product types, the first product type being associated with the first network provisioning service. In some examples, each orchestrator is further configured to request first transaction data among a plurality of transaction data from a transaction factory based on the first product type. In some instances, the first transaction data includes a first ordered list of tasks for the first product type. In some cases, the first ordered list of tasks includes the first task among the one or more DyCon IPVPN tasks. In some examples, a task type of the first task is the task type on which the request for the first task manager is based.

According to some embodiments, the system further includes a controller configured to trigger one or more DyCon IPVPN functionalities in response to receiving the request to perform the first network provisioning service. The system further includes the orchestrator factory configured to select and return the first orchestrator among the plurality of orchestrators based on the first product type associated with the first network provisioning service. The system further includes the transaction factory configured to perform one of: (A) accessing one or more template files associated with the plurality of product types, the one or more template files including an ordered list of tasks for each product type; determining, from a first template file among the one or more template files, the first transaction data, including the first ordered list of tasks; and sending the first transaction data, including the first ordered list of tasks, to the first orchestrator; or (B) determining the first transaction data, including the first ordered list of tasks, based on the product type; generating the first template file based on the determination; and sending the first template file as the first transaction data, including the first ordered list of tasks, to the first orchestrator. The system further includes the task factory configured to select and return the first task manager based on the task type associated with the first task.

Merely by way of example, in some cases, the one or more DyCon IPVPN tasks include at least one of one or more virtual routing and forwarding (“VRF”) tasks; one or more network as a service (“NaaS”) IPVPN tasks; one or more NaaS API framework for queue management (“FQM”) tasks; one or more layer 3 VPN tasks; one or more layer 3 VPN API FQM tasks; one or more billing tasks; one or more billing API FQM tasks; or one or more inventory tasks; and/or the like. In some instances, the one or more VRF tasks include at least one of building a VRF instance; deleting a VRF instance; or updating a VRF instance; and/or the like. In some cases, the one or more NaaS IPVPN tasks include at least one of building a NaaS IPVPN network; deleting a NaaS IPVPN network; or updating a NaaS IPVPN network; and/or the like. In some examples, the one or more NaaS API FQM tasks include at least one of creating a NaaS API FQM; or deleting a NaaS API FQM; and/or the like. In examples, the one or more layer 3 VPN tasks include at least one of building a layer 3 VPN network; deleting a layer 3 VPN network; or updating a layer 3 VPN network; and/or the like. In some instances, the one or more layer 3 VPN API FQM tasks includes at least one of creating a layer 3 VPN API FQM; or deleting a layer 3 VPN API FQM; and/or the like. In some cases, the one or more billing tasks include at least one of building a billing record; deleting a billing record; or updating a billing record; and/or. In some examples, the one or more billing API FQM tasks include at least one of creating a billing API FQM; or deleting a billing API FQM; and/or the like. In examples, the one or more inventory tasks include at least one of updating a network resource inventory; or auditing a network resource inventory; and/or the like.

In some embodiments, each task manager is further configured to perform at least one of handling one or more task failures associated with implementing the first task; requesting a first NaaS service system among a plurality of NaaS service systems from a NaaS API factory based on a first resource type associated with the first task; or instructing the first NaaS service system to perform one of building a NaaS API associated with the first NaaS service system; deleting a NaaS API associated with the first NaaS service system: or obtaining a status of building or deleting a NaaS API associated with the first NaaS service system; and/or the like. In some cases, the plurality of NaaS service systems includes at least one a NaaS IP service system, a NaaS virtual private cloud (“VPC”) service system, a NaaS IPVPN network service system, or a NaaS layer 3 VPN service system, and/or the like. In some instances, triggering execution of the first task includes instructing, via the NaaS API, a downstream system to execute the first task.

In some instances, the system further includes a callback controller configured to receive a callback message from the downstream system indicating that the first task has been successfully completed; request a second orchestrator among the plurality of orchestrators to perform one of a second task among the one or more DyCon IPVPN tasks associated with the first network provisioning service or a second network provisioning service among the plurality of network provisioning services; and instruct the second orchestrator to perform the one of the second task or the second network provisioning service. In some cases, the callback controller is further configured to perform an update function including at least one of finding a database record matching a product instance identifier (“ID”) of a first product associated with the first task; finding a transaction within a service data transfer object (“DTO”) model matching a transaction ID of a transaction associated with the first product and the first task; finding a task with the transaction matching a task ID and a task type of the first task; calling a task manager among the plurality of task managers to update a task status of the first task; updating the first transaction; or updating the first network provisioning service; and/or the like. In some examples, the callback controller is further configured to, based on a determination that a task status of the first task is success, initiate implementation of a next task in the first ordered list of tasks. In examples, the callback controller is further configured to, based on a determination that the first task is a critical build task and that the task status of the first task is failure, initiating a rollback process and updating an IPVPN state to reflect activation failure. In some cases, the callback controller is further configured to, based on a determination that the first task is a non-critical build task and that the task status of the first task is failure, proceed with a next task among the one or more DyCon IPVPN tasks. In some instances, the callback controller is further configured to, based on a determination that the first task is a critical delete task and that the task status of the first task is failure, stopping process of deletion and updating the IPVPN state to reflect disconnection failure. In some examples, the callback controller is further configured to, based on a determination that the first task is a non-critical delete task and that the task status of the first task is failure, proceed with the next task among the one or more DyCon IPVPN tasks.

According to some embodiments, the plurality of orchestrators includes at least one of an IPVPN service orchestrator, an IPVPN network orchestrator, or a DyCon IPVPN orchestrator. In some instances, the plurality of task managers includes at least one of a NaaS task manager, a billing task manager, or a DyCon IPVPN task manager. In some cases, the request is included in user input that is received from a user device via an a DyCon IPVPN API. In some examples, the DyCon IPVPN system is implemented within one or more virtual machines (“VMs”).

In another aspect, the technology relates to a method, including, in response to receiving a request to build an IPVPN, requesting, by a computing system and from an orchestrator factory, a first orchestrator among a plurality of orchestrators based on a first product type that is associated with the IPVPN in the request; and instructing, by the computing system, the first orchestrator to orchestrate building of the IPVPN, by requesting a first task manager among a plurality of task managers from a task factory based on a task type associated with a task of building the IPVPN; and instructing the first task manager to build, or to cause building of, the IPVPN.

In some embodiments, the computing system includes at least one of a DyCon IPVPN system, a DyCon IPVPN controller, a DyCon IPVPN gateway device, a DyCon IPVPN orchestrator, a NaaS workflow engine, a server, a cloud computing system, or a distributed computing system, and/or the like.

According to some embodiments, instructing the first orchestrator to orchestrate building of the IPVPN further includes instructing, by the computing system, the first orchestrator to request first transaction data among a plurality of transaction data from a transaction factory based on the first product type. In some examples, the first transaction data includes a first ordered list of tasks for the first product type. In some cases, the first ordered list of tasks includes the first task among the one or more DyCon IPVPN tasks. In some instances, a task type of the first task is the task type on which the request for the first task manager is based. In examples, the transaction factory generates a first template file associated with the first product type that is related to building IPVPNs and sends the first template file as the first transaction data to the first orchestrator, the first template file including an ordered list of tasks for building IPVPNs. In some examples, the transaction factory accesses one or more template files associated with a plurality of product types, the one or more template files including an ordered list of tasks for each product type. In some cases, the transaction factory determines, from a first template file among the one or more template files, the first transaction data, including the first ordered list of tasks, and sends the first transaction data, including the first ordered list of tasks, to the first orchestrator.

In some embodiments, building of the IPVPN follows a first ordered list of tasks in which the tasks are performed in a first order. In some examples, the method further includes, in response to receiving a request to delete the IPVPN, instructing, by the computing system, the first orchestrator to orchestrate deleting of the IPVPN, by instructing the first task manager to delete, or to cause deletion of, the IPVPN, by implementing a delete workflow based on a second ordered list of tasks; and instructing each downstream system to return a callback message to a callback system indicating when each delete task that is handled by said downstream system has been successfully completed or has failed. In some cases, delete tasks in the second ordered list of tasks correspond to build tasks in the first ordered list that are labelled in the first transaction data or the first template file as being included in the delete workflow. In some instances, the second ordered list of tasks includes delete tasks for deleting the IPVPN in a second order that is a reverse of the first order except that delete tasks corresponding to build tasks in the first ordered list that are labelled in the first transaction data or the first template file as not having delete dependency are triggered asynchronously at a beginning of the delete workflow.

In yet another aspect, the technology relates to a method, including receiving, by a task manager of a system and from an orchestrator of the system, a request to perform a first task among one or more DyCon IPVPN tasks; and performing, by the task manager, the following: creating the first task; triggering execution of the first task; and updating the first task. In some examples, triggering execution of the first task, after creating the first task, comprises: requesting, by the task manager and from a NaaS API factory, a first NaaS service system among a plurality of NaaS service systems based on a first resource type associated with the first task; and instructing, by the task manager, the first NaaS service system to perform one of building a NaaS API associated with the first NaaS service system; deleting a NaaS API associated with the first NaaS service system; or obtaining a status of building or deleting a NaaS API associated with the first NaaS service system; and/or the like.

In some embodiments, the system includes at least one of a DyCon IPVPN system, a NaaS workflow engine, a server, a cloud computing system, or a distributed computing system, and/or the like. According to some embodiments, the method further includes handling, by the task manager, one or more task failures associated with implementing the first task; and/or the like. In some instances, the plurality of NaaS service systems includes at least one a NaaS IP service system, a NaaS VPC service system, a NaaS IPVPN network service system, or a NaaS layer 3 VPN service system, and/or the like. In some cases, triggering execution of the first task further includes instructing, by the task manager and via the NaaS API, a downstream system to execute the first task. In examples, updating the first task includes updating the first task based on callback information from the downstream system regarding whether or not execution of the first task was successful.

Merely by way of example, in some cases, the one or more DyCon IPVPN tasks include at least one of one or more VRF tasks; one or more NaaS IPVPN tasks; one or more NaaS API FQM tasks; one or more layer 3 VPN tasks; one or more layer 3 VPN API FQM tasks; one or more billing tasks; one or more billing API FQM tasks; or one or more inventory tasks; and/or the like. In some instances, the one or more VRF tasks include at least one of building a VRF instance; deleting a VRF instance; or updating a VRF instance; and/or the like. In some cases, the one or more NaaS IPVPN tasks include at least one of building a NaaS IPVPN network; deleting a NaaS IPVPN network; or updating a NaaS IPVPN network; and/or the like. In some examples, the one or more NaaS API FQM tasks include at least one of creating a NaaS API FQM; or deleting a NaaS API FQM; and/or the like. In examples, the one or more layer 3 VPN tasks include at least one of building a layer 3 VPN network; deleting a layer 3 VPN network; or updating a layer 3 VPN network; and/or the like. In some instances, the one or more layer 3 VPN API FQM tasks includes at least one of creating a layer 3 VPN API FQM; or deleting a layer 3 VPN API FQM; and/or the like. In some cases, the one or more billing tasks include at least one of building a billing record; deleting a billing record; or updating a billing record; and/or. In some examples, the one or more billing API FQM tasks include at least one of creating a billing API FQM; or deleting a billing API FQM; and/or the like. In examples, the one or more inventory tasks include at least one of updating a network resource inventory; or auditing a network resource inventory; and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

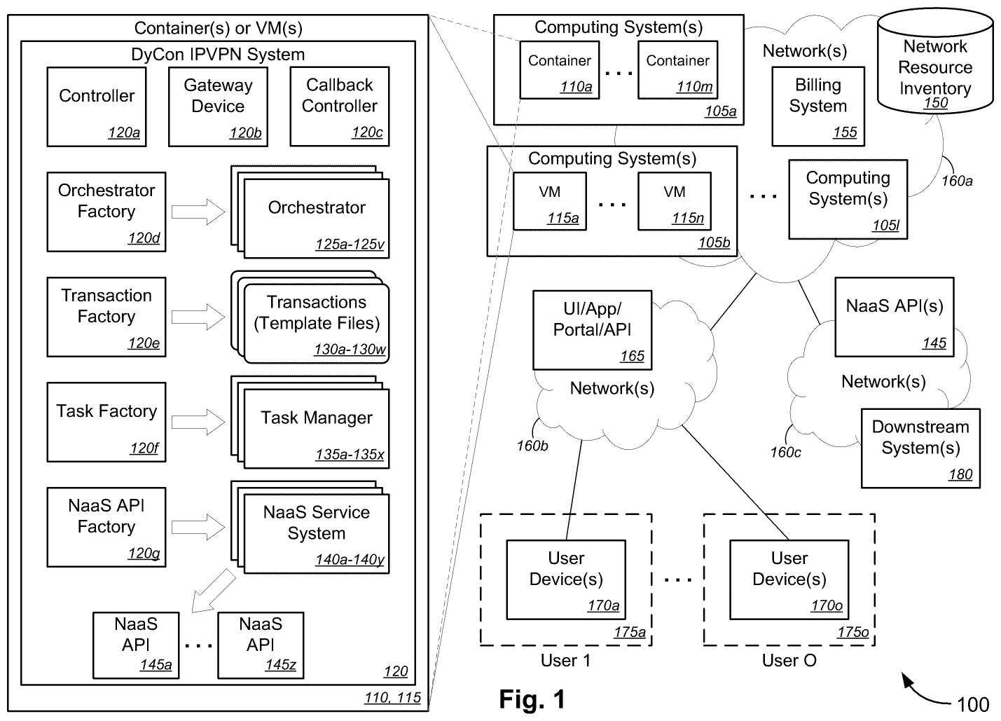

We now turn to the embodiments as illustrated by the drawings. FIGS. 1-5 illustrate some of the features of the method, system, and apparatus for implementing provisioning of network services, and, more particularly, to methods, systems, and apparatuses for implementing dynamic connections (“DyCon”) Internet Protocol (“IP”) virtual private network (“VPN”) functionalities, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing DyCon IPVPN functionalities, in accordance with various embodiments. In the non-limiting example of FIG. 1, system 100 includes one or more computing systems 105a-1051 (collectively, “computing systems 105”), each of which may include either one or more containers 110a-110m (collectively, “containers 110”; such as shown with respect to computing system(s) 105a) or one or more virtual machines (“VMs”) 115a-115n (collectively, “VMs 115”; such as shown with respect to computing system(s) 105b) that may be implemented or run thereon. A container, as used herein, refers to a logical packaging in which software applications can be abstracted from the environment in which they are actually run or executed, by holding all the components (e.g., files, libraries, and environment variables) necessary for running or executing the software applications. A VM, as used herein, refers to a virtual computer system that emulates the functionality of a physical computer. In examples, each computing system 105 is a machine where containers or VMs are hosted or deployed, where the machine is either a physical computing system or a virtual computing system, and contains the associated components (e.g., container engine, host operating system, and infrastructure for machines hosting containers; or hypervisor and infrastructure for machines hosting VMs; etc.).

On the container(s) 110 or the VM(s) 115 may be run or implemented a DyCon IPVPN system 120. The DyCon IPVPN system 120 may include a controller or DyCon IPVPN controller 120a, a gateway device or DyCon IPVPN façade system 120b, a callback controller 120c, and a plurality of factories 120d-120g. In some examples, the plurality of factories 120d-120g may include an orchestrator factory 120d, a transaction factory 120e, a task factory 120f, and/or a NaaS API factory 120g. In some instances, the orchestrator factory 120d is configured to select an orchestrator 125 among a plurality of orchestrators 125a-125v (collectively, “orchestrators 125”), based on a product type associated with a network provisioning service that may be requested by a user (e.g., a user among users 1 through O 175a-1750), the product type being among a plurality of product types. The orchestrator factory 120d is further configured to return the orchestrator 125 to the gateway device 120b with which the orchestrator factory 120d is in communication.

In an example, the transaction factory 120e is configured to access one or more template files (e.g., YAML, .yaml, or .yml files, or the like) associated with the plurality of product types, the one or more template files including an ordered list of tasks for each product type; determine, from a template file among the one or more template files, transaction data or transaction 130 among a plurality of transaction data or transactions 130a-130w (collectively, “transaction data 130” or “transactions 130”) including the ordered list of tasks, for the product type associated with the network provisioning service that may be requested by the user; and send the transaction data 130 including the ordered list of tasks to an orchestrator 125 with which the transaction factory 120e is in communication. In another example, the transaction factory 120f is configured to determine the transaction data 130 including the ordered list of tasks, based on the product type associated with the network provisioning service that may be requested by the user; generate the template file based on the determination; and send the template file as the transaction data 130 including the ordered list of tasks to the orchestrator 125.

In some cases, the task factory 120f is configured to select a task manager 135 among a plurality of task managers 135a-135x (collectively, “task managers 135”), based on a task type associated with the task among the ordered list of tasks for the product type associated with the network provisioning service that may be requested by the user. The task factory 120f is further configured to return the task manager 135 to transaction factory 120e and/or to the orchestrator 125 with which the task factory 120f is in communication. In some examples, the NaaS API factory 120g is configured to select a NaaS service system 140 among a plurality of NaaS service systems 140a-140y (collectively, “NaaS service systems 140”), based on a resource type associated with the task among the ordered list of tasks for the product type associated with the network provisioning service that may be requested by the user. The NaaS API factory 120g is further configured to return the NaaS service system 140 to the task manager 135 with which the NaaS API factory 120g is in communication. The task manager 135 is further configured to instruct the selected NaaS service 140 to perform the task or to cause a downstream system (e.g., downstream system(s) 180), via a NaaS API(s) 145 among a plurality of NaaS APIs 145a-145z (collectively, “NaaS APIs 145” or “APIs 145”). Herein, l, m, n, O (or o), v, w, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

Herein, “returning the orchestrator” may refer to one of sending the selected orchestrator or an instance thereof (as executed code), sending code that when executed implements the selected orchestrator (or an instance thereof), sending data for accessing the selected orchestrator (or an instance thereof), or sending data for implementing the selected orchestrator (or an instance thereof). Similarly, “returning the task manager” may refer to one of sending the selected task manager or an instance thereof (as executed code), sending code that when executed implements the selected task manager (or an instance thereof), sending data for accessing the selected task manager (or an instance thereof), or sending data for implementing the selected task manager (or an instance thereof). Likewise, “returning the NaaS service system” may refer to one of sending the selected NaaS service system or an instance thereof (as executed code), sending code that when executed implements the selected NaaS service system (or an instance thereof), sending data for accessing the selected NaaS service system (or an instance thereof), or sending data for implementing the selected NaaS service system (or an instance thereof).

In some embodiments, system 100 may further include a network resource inventory 150 and a billing system 155. The network resource inventory 150 is configured to store information regarding network resources that are used by the DyCon IPVPN system 120 and/or the network for performing the one or more DyCon IPVPN functionalities or tasks. The billing system 155 is configured to determine network resources used when the one or more DyCon IPVPN functionalities or tasks are implemented and to perform one or more billing tasks associated with billing users for use of the network resources. Merely by way of example, in some cases, the one or more DyCon IPVPN tasks may include at least one of one or more virtual routing and forwarding (“VRF”) tasks; one or more NaaS IPVPN tasks; one or more NaaS API framework for queue management (“FQM”) tasks; one or more layer 3 VPN tasks; one or more layer 3 VPN API FQM tasks; one or more billing tasks; one or more billing API FQM tasks; or one or more inventory tasks; and/or the like. In some instances, the one or more VRF tasks include at least one of building a VRF instance; deleting a VRF instance; or updating a VRF instance; and/or the like. In some cases, the one or more NaaS IPVPN tasks include at least one of building a NaaS IPVPN network; deleting a NaaS IPVPN network; or updating a NaaS IPVPN network; and/or the like. In some examples, the one or more NaaS API FQM tasks include at least one of creating a NaaS API FQM; or deleting a NaaS API FQM; and/or the like. In examples, the one or more layer 3 VPN tasks include at least one of building a layer 3 VPN network; deleting a layer 3 VPN network; or updating a layer 3 VPN network; and/or the like. In some instances, the one or more layer 3 VPN API FQM tasks includes at least one of creating a layer 3 VPN API FQM; or deleting a layer 3 VPN API FQM; and/or the like. In some cases, the one or more billing tasks include at least one of building a billing record; deleting a billing record; or updating a billing record; and/or. In some examples, the one or more billing API FQM tasks include at least one of creating a billing API FQM; or deleting a billing API FQM; and/or the like. In examples, the one or more inventory tasks include at least one of updating the network resource inventory 150; or auditing a network resource inventory 150; and/or the like.

According to some embodiments, the computing system(s) 105a-1051, the NaaS API(s) 145, the network resource inventory 150, the billing system 155, and the downstream system(s) 180 may be located, disposed, or implemented within one or more networks 160a-160c (collectively, “network(s) 160”). System 100 may further include at least one of a user interface(s) (“UI(s)”), a software application(s) (“app(s)”), a (web) portal(s), and/or an API(s) 165 (collectively, “interface(s) 165”) that is located, disposed, or implemented within the one or more networks 160a-160c, the interface(s) 165 enabling one or more user devices 170a-1700 (collectively, “user devices 170”) that are associated with one or more users 175a-1750 (collectively, “users 175”) to communicatively couple with the computing system(s) 105 and/or the DyCon IPVPN system 120 (or components therein). In some cases, the billing system 155 may also communicate with the one or more user devices 170 via the interface(s) 165 over the network(s) 160a-160c.

In some examples, the computing system includes at least one of a DyCon IPVPN system (e.g., DyCon IPVPN system 120), a DyCon IPVPN controller (e.g., controller 120a), a DyCon IPVPN gateway device (e.g., gateway device 120b), a DyCon IPVPN orchestrator (e.g., orchestrator(s) 125a-125v), a NaaS workflow engine, a server, a cloud computing system, or a distributed computing system, and/or the like. In some instances, the user device(s) 170 may each include, but is not limited to, one of a desktop computer, a laptop computer, a tablet computer, a smart phone, a mobile phone, a network operations center (“NOC”) computing system or console, or any suitable device capable of communicating with network(s) 160 or with servers or other network devices within network(s) 160, or via any suitable device capable of communicating with at least one of the computing system(s) 105, the DyCon IPVPN system 120 (or components therein), the network resource inventory 150, the billing system 155, and/or the downstream system(s) 180, and/or the like, via a web-based portal, an API, a server, an app, or any other suitable communications interface (e.g., interface(s) 165), or the like, over network(s) 160. In some cases, users 175 may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. In some examples, the downstream system(s) 180 may each include a server, a network node, a computing system, or any other suitable machine for implementing the DyCon IPVPN tasks, said machine being separate from the DyCon IPVPN system 120 or being external to the container(s) 110 or the VM(s) 115. In some cases, the downstream system(s) 180 may include the billing system 155, an activation configuration tool (“ACT”), and/or an enterprise message platform (“EMP”), and/or the like. In some instances, the ACT may be a system, device, or API that is configured to put network configurations on network devices (e.g., a provider edge (“PE”) router or other PE device, etc.). In examples, the EMP may be a platform message queue system or message bus over which messages (e.g., thousands of messages) may be consumed by other systems (in some cases, using a publication/subscription (“pub/sub”) messaging system or the like).

According to some embodiments, networks 160a-160c may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a VPN; the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 160a-160c may include an access network of the service provider (e.g., an Internet service provider (“ISP”)). In another embodiment, the networks 160a-160c may include a core network of the service provider and/or the Internet.

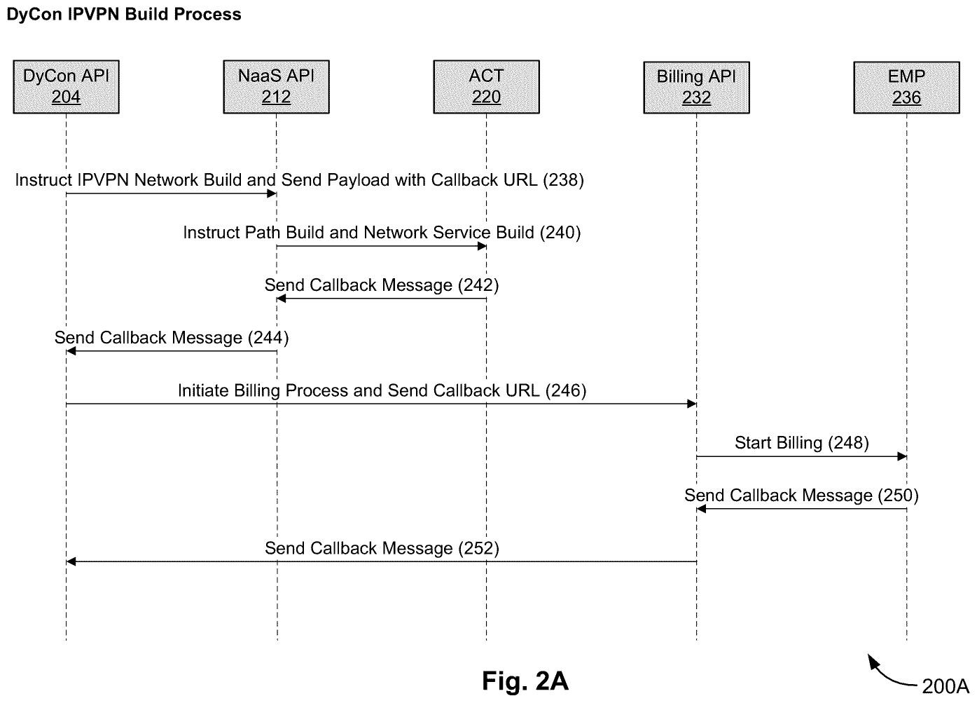

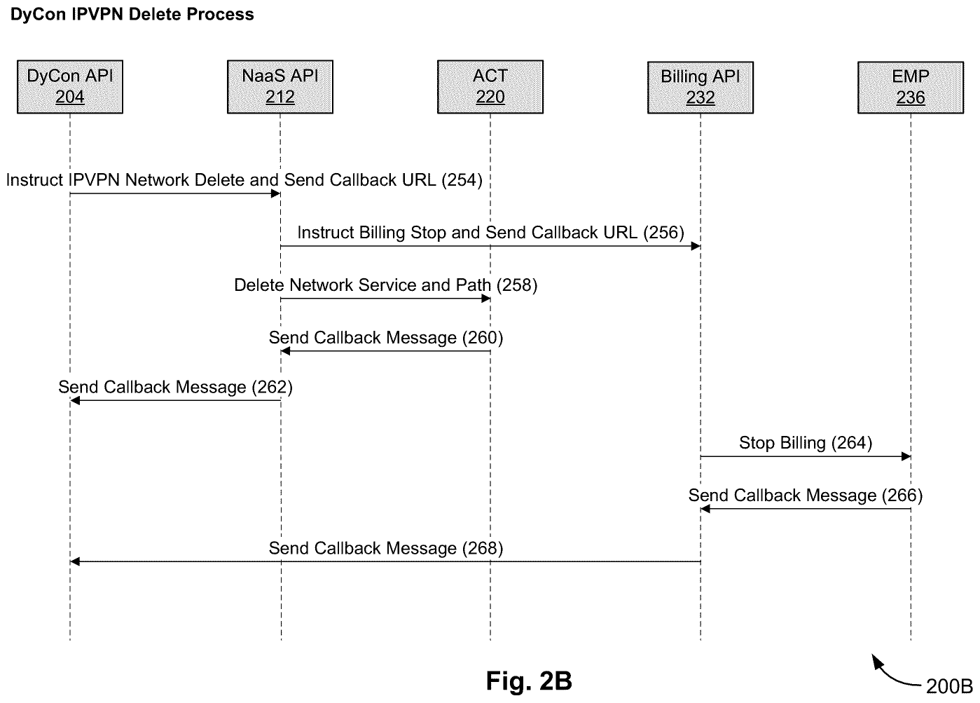

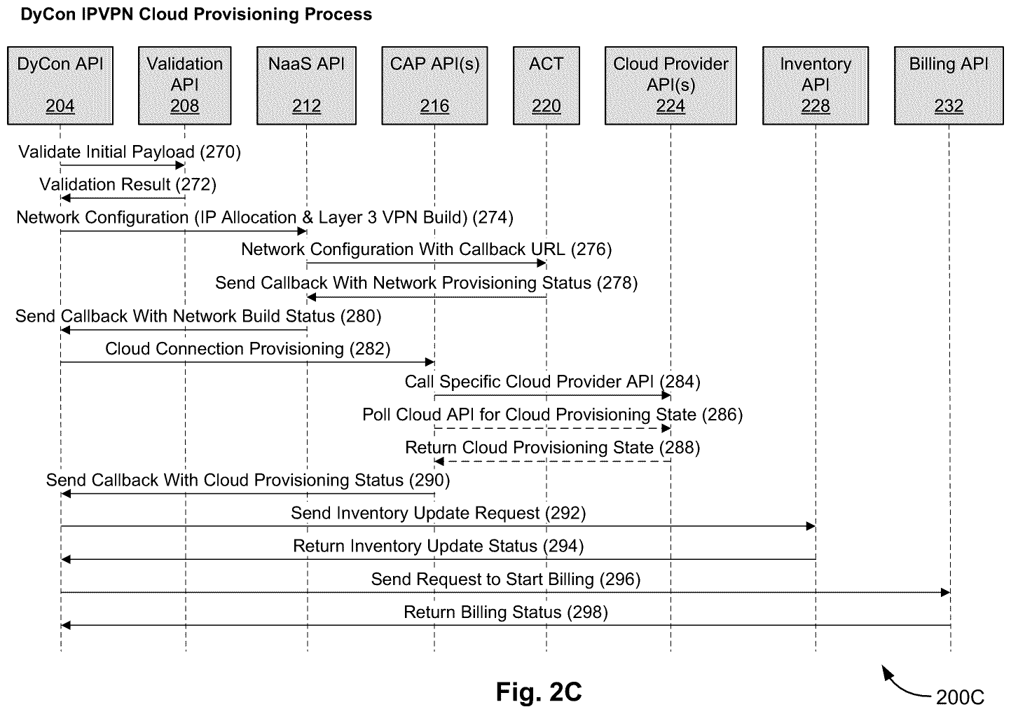

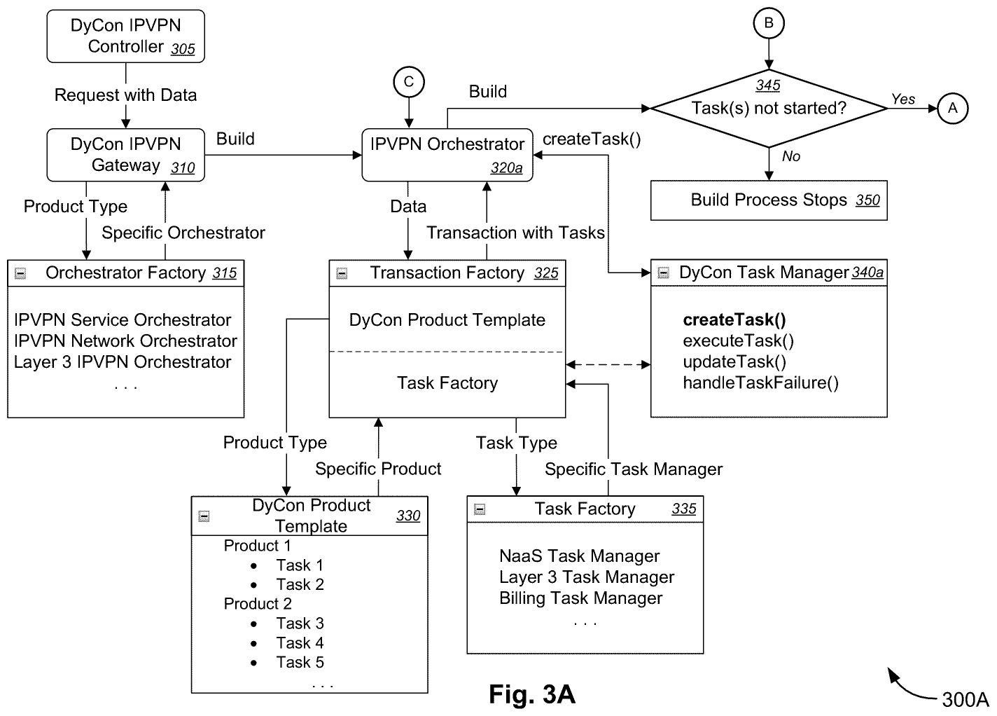

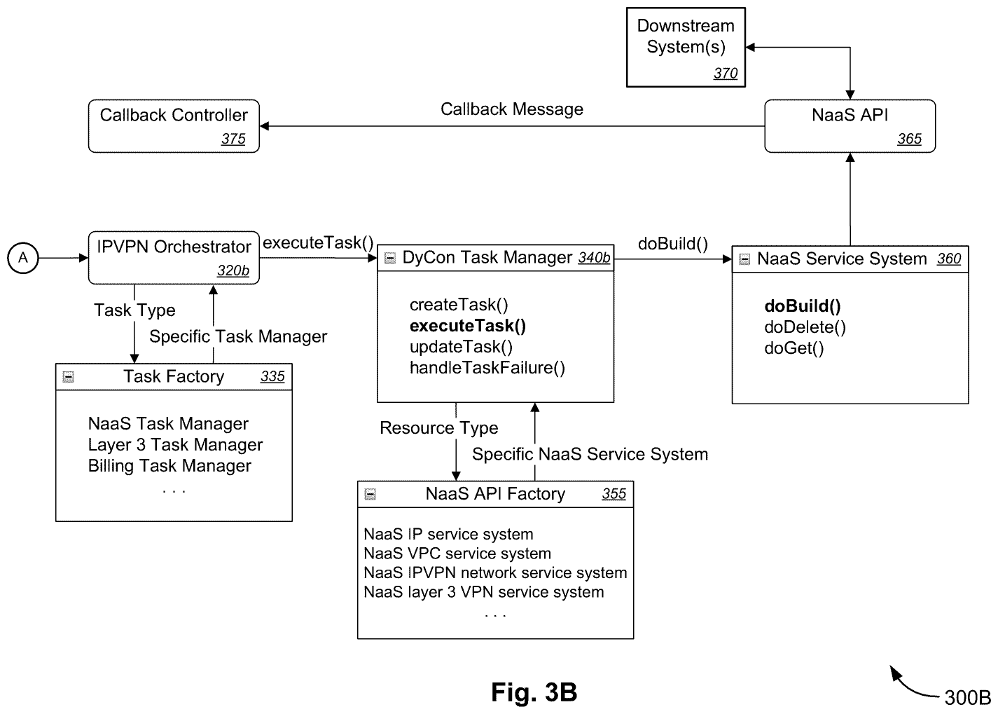

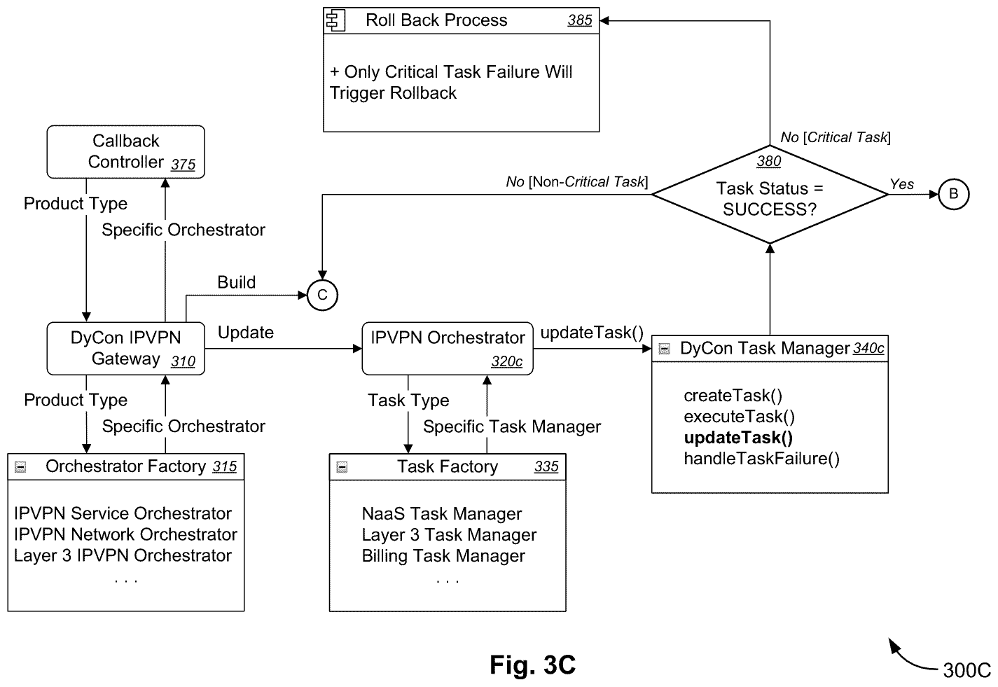

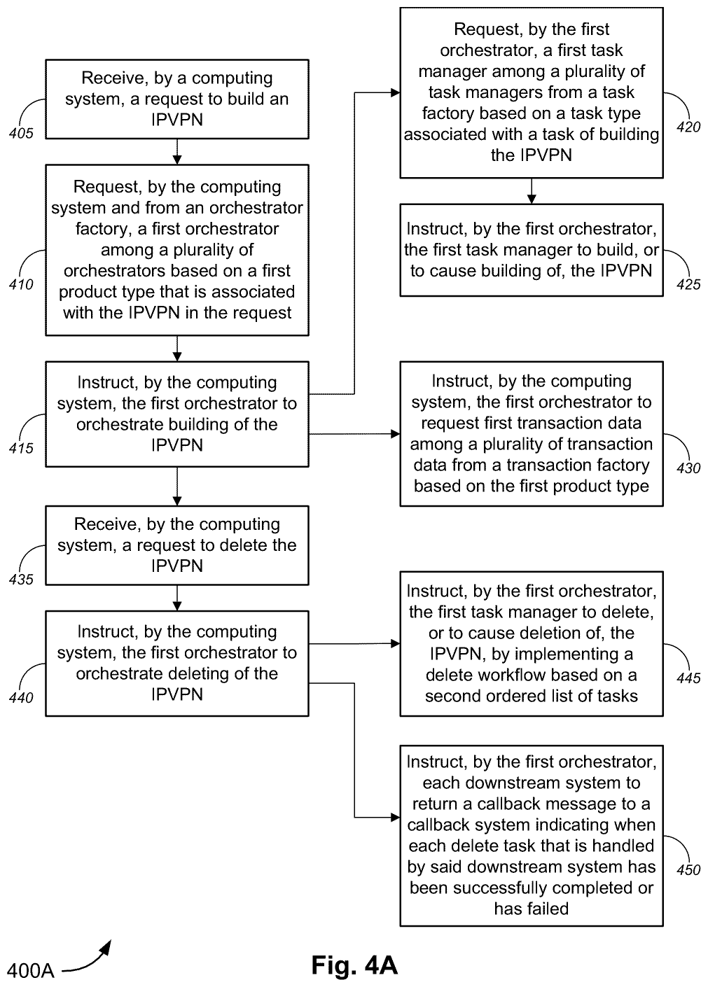

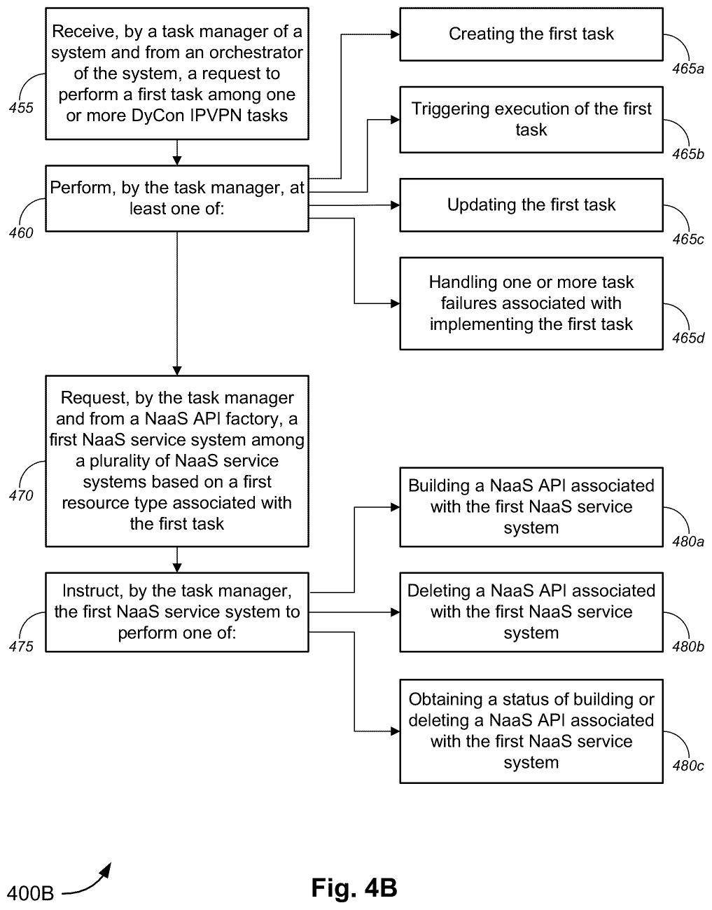

In operation, computing system(s) 105a-105c, DyCon IPVPN system 120, controller 120a, gateway device 120b, callback controller 120c, orchestrator(s) 125a-125y, task manager(s) 135a-135x, NaaS service system(s) 140a-140y, and/or orchestrator 115a or 115b (collectively, “computing system”) may perform methods for implementing DyCon IPVPN functionalities, as described in detail with respect to FIGS. 2-4. For example, example sequence flow 200A of FIG. 2A is directed to implementing an example DyCon IPVPN build process, while example sequence flow 200B of FIG. 2B is directed to implementing an example DyCon IPVPN delete process, and example sequence flow 200C of FIG. 2C is directed to implementing an example DyCon IPVPN cloud provisioning process. Example sequence flows 300A-300C of FIGS. 3A-3C are directed to implementing example DyCon IPVPN functionalities. FIGS. 4A and 4B are directed to a method for implementing DyCon IPVPN functionalities.

FIGS. 2A-2C (collectively, “FIG. 2”) depict various example sequence flows 200A, 200B, and 200C for implementing various DyCon IPVPN functionalities. In particular, FIG. 2A depicts an example sequence flow 200A for implementing an example DyCon IPVPN build process, in accordance with various embodiments. FIG. 2B depicts an example sequence flow 200B for implementing an example DyCon IPVPN build process, in accordance with various embodiments. FIG. 2C depicts an example sequence flow 200C for implementing an example DyCon IPVPN cloud provisioning process, in accordance with various embodiments. In some embodiments, DyCon IPVPN API 204, NaaS API 212, inventory API 228, and/or billing API 232, and validation API 208, cloud application platform (“CAP”) API(s) 216, ACT 220, cloud provider API(s) 224, and/or EMP 236 of FIG. 2 may be similar, if not identical, to the interface(s) 165, the NaaS API(s) 145, and the downstream system(s) 180, respectively, of system 100 of FIG. 1, and the description of these components of system 100 of FIG. 1 are similarly applicable to the corresponding components of FIG. 2. In examples, the inventory API 228 may be associated (or connected) with network resource inventory 150 of FIG. 1, while the billing API 232 may be associated (or connected) with billing system 155 of FIG. 1. In some examples, the downstream system(s) 180 may include a validation system (not shown; with which validation API 208 may be associated or connected), a CAP or CAP system (not shown; with which CAP API 216 may be associated or connected), and cloud provider system(s) (not shown; with which cloud provider API 224 may be associated or connected). As used herein, CAP API(s) refers to an API(s) for a cloud application platform, which is a third-party platform for connecting users with other third-party cloud service providers that manage or control cloud provider systems that provision cloud services.

With reference to the non-limiting example sequence flow 200A of FIG. 2A, the DyCon API 204 may instruct building of an IPVPN network and may send payload data with a callback uniform resource locator (“URL”) to NaaS API 212 (at operation 238). The payload data may include information (e.g., information that may be sent by a task manager 135 of FIG. 1, or the like) that may be used for a downstream system(s) (e.g., downstream system(s) 180 of FIG. 1 or the like) to implement the DyCon IPVPN functionalities or tasks. At operation 240, the NaaS API 212 may instruct ACT 220 to build a network path and to build network services. The ACT 220 may perform corresponding operations for implementing the network path build and the network services build, including configuring network devices, setting communication pathways between network devices, etc. At operation 242, ACT 220 sends a callback message to the NaaS API 212, which sends a similar callback message to the DyCon API (at operation 244). The callback messages (that are sent at operations 242 and 244) may each indicate whether the network path build operations and the network services build operations were successful or encountered failures (either total failures or partial failures), in some cases, including detailed information regarding the successes or failures. At operation 246, in response to receiving a callback message (at operation 244) indicating success, DyCon API 204 may initiate billing process and may send a callback URL to billing API 232, which may start the billing process via EMP 236 (at operation 248), which relays over its messaging channels or bus to a billing system (e.g., billing system 155 of FIG. 1 or the like) instructions to start the billing process. At operation 250, EMP 236 subsequently sends a callback message to the billing API 232, which sends a similar callback message to the DyCon API (at operation 252). The callback messages (that are sent at operations 250 and 252) may each indicate whether the start billing process was successful or unsuccessful.

Referring to the non-limiting example sequence flow 200B of FIG. 2B, the DyCon API 204 may instruct deleting of an IPVPN network and may send payload data with a callback uniform resource locator (“URL”) to NaaS API 212 (at operation 254). At operation 256, the NaaS API 212 may instruct billing API 232 to stop billing and to send a callback URL. Concurrently or sequentially, the NaaS API 212 may send instructions to ACT 220 to delete the network service and the network path, at operation 258. At operation 260, ACT 220 sends a callback message to the NaaS API 212, which sends a similar callback message to the DyCon API (at operation 262). The callback messages (that are sent at operations 260 and 262) may each indicate whether the network path delete operations and the network services delete operations were successful or encountered failures (either total failures or partial failures), in some cases, including detailed information regarding the successes or failures. At operation 264, in response to receiving billing stop instructions and the callback message (sent at operation 256), billing API 232 may stop (or cause stop of) the billing process via EMP 236 (at operation 264), which relays over its messaging channels or bus to the billing system (e.g., billing system 155 of FIG. 1 or the like) instructions to stop the billing process. At operation 266, EMP 236 subsequently sends a callback message to the billing API 232, which sends a similar callback message to the DyCon API (at operation 268). The callback messages (that are sent at operations 266 and 268) may each indicate whether the stop billing process was successful or unsuccessful.

Turning to the non-limiting example sequence flow 200C of FIG. 2C, the DyCon API 204 may instruct validation API 208 to validate an initial payload (at operation 270). At operation 272, the validation API 208 may return the validation result to DyCon API 204. In some cases, the initial payload or payload data may include information (e.g., information that may be sent by a task manager 135 of FIG. 1, or the like) that may be used for a downstream system(s) (e.g., downstream system(s) 180 of FIG. 1 or the like) to implement the DyCon IPVPN functionalities or tasks, such as cloud provisioning functionalities or tasks, etc. At operation 274, DyCon API 204 may send network configuration (e.g., network configuration data for IP allocation and layer 3 VPN build) to NaaS API 212, which may send or relay the network configuration together with callback URL to ACT 220 (at operation 276). At operation 278, ACT 220 may send a callback message with network provisioning status to NaaS API 212, which may send or relay the callback message with network build status back to DyCon API 204 (at operation 280). At operation 282, DyCon API 204 may send, to CAP API(s) 216, a request for cloud connection provisioning. At operation 284, CAP API(s) 216 may call a specific cloud provider API(s) 224. CAP API(s) 216 may further poll the cloud provider API(s) 224 for a provisioning state (at operation 286). The cloud provider API(s) 224 may return the provisioning state to the CAP API(s) 216 (at operation 288), and the CAP API(s) 216 may send a callback message with cloud provisioning status to DyCon API 204 (at operation 290). At operation 292, DyCon API 204 may send an inventory update request to inventory API 228, which may return an inventory update status to the DyCon API 204 (at operation 294). At operation 296, DyCon API 204 may send, to billing API 232, a request to start billing, and the billing API 232 may return a billing status to the DyCon API 204 (at operation 298).

These and other functions of the examples 200A, 200B, and 200C (and their components) are described in greater detail herein with respect to FIGS. 1, 3, and 4.

FIGS. 3A-3C (collectively, “FIG. 3”) depict various example sequence flows 300A, 300B, and 300C for implementing DyCon IPVPN functionalities, in accordance with various embodiments. Sequence flow 300A (e.g., a sequence for creating a task) continues onto sequence flow 300B (e.g., a sequence for executing a task) in FIG. 3B, following the circular marker denoted, “A.” Sequence flow 300B in FIG. 3B continues onto sequence flow 300C (e.g., a sequence for updating a task) in FIG. 3C via callback controller 375. Sequence flow 300C in FIG. 3C returns to sequence flow 300A in FIG. 3A via circular marker denoted, “B,” or circular marker denoted, “C.” In some embodiments, DyCon IPVPN controller 305, DyCon IPVPN gateway 310, orchestrator factory 315, IPVPN orchestrator(s) 320a-320c, transaction factory 325, DyCon product template 330, task factory 335, DyCon task manager(s) 340a-340c, NaaS API factory 355, NaaS service system 360, NaaS API 365, downstream system(s) 370, and callback controller 375 of FIG. 3 may be similar, if not identical, to controller 120a, gateway device 120b, orchestrator factory 120d, orchestrator(s) 125a-125v, transaction factory 120e, transactions including template files 130a-130w, task factory 120f, task manager(s) 135a-135x, NaaS API factory 120g, NaaS service system(s) 140a-140y, NaaS API(s) 145 and 145a-145z, downstream system(s) 180, and callback controller 120c, respectively, of system 100 of FIG. 1, and the description of these components of system 100 of FIG. 1 are similarly applicable to the corresponding components of FIG. 3.

With reference to example sequence flow 300A in FIG. 3A, in response to receiving user input requesting to perform a first network provisioning service among a plurality of network provisioning services from a user device associated with a user (e.g., one of user devices 170a-1700 associated with a corresponding one of users 175a-1750, or the like), DyCon IPVPN controller 205 may send, to DyCon IPVPN gateway 310, a request to perform the first network provisioning service with corresponding data. In some examples, the data contained in the request includes a first product type among a plurality of product types, the first product type being associated with the first network provisioning service. DyCon IPVPN gateway 310 requests a first orchestrator among a plurality of orchestrators from orchestrator factory 315, based on (or using) the data contained in the request and/or the first product type. In examples, the plurality of orchestrators may include an IPVPN service orchestrator, an IPVPN network orchestrator, a layer 3 IPVPN orchestrator, and/or the like. In some examples, the plurality of orchestrators represents multiple types of orchestrators with one or more instances of each type being implemented during operation. After the orchestrator factory 315 returns the first orchestrator 320a (where “returning the orchestrator” is described in detail above with respect to FIG. 1), DyCon IPVPN gateway 310 instructs the first orchestrator 320a to perform the first network provisioning service.

The first orchestrator 320a requests first transaction data among a plurality of transaction data from a transaction factory 325, based on the first product type or the data contained in the request. In some instances, the first transaction data includes a first template file (e.g., DyCon product template 330). In an example, such as shown in FIG. 3A, the DyCon product template 330 (e.g., a YAML file, or the like) lists products (e.g., products 1 and 2) as well as an ordered list of tasks for each product (e.g., tasks 1 and 2 for product 1, and tasks 3-5 for product 2, etc.). Herein, “product” or “DyCon product” may refer to an IPVPN product or service that is provisioned by a network service provider, or the like. In an example, transaction factory 325 accesses the first template file associated with the first product type; determines, from the first template file, the first transaction data, including a first ordered list of tasks for the first product type; and sends the first transaction data, including the first ordered list of tasks, to the first orchestrator 320a. Alternatively, in another example, transaction factory 325 determines the first transaction data, including the first ordered list of tasks, based on the first product type; generates the first template file based on the determination; and sends the first template file as the first transaction data, including the first ordered list of tasks, to the first orchestrator 320a. An example template file or example transaction data may be as follows:

```
“transactions” : [
  {
    “transactionId” : “88aa248b-78af-46d0-beaf-d532518c1094”,
    “action” : “ACTIVATE”,
    “request” : {request payload},
    “startDate” : “2023-06-10 10:33:55”,
    “endDate” : “2023-06-11 14:03:13”,
    “status”: “SUCCESS” / “FAILURE”
    “tasks” : [
      {
        “_id” : “1”,
        “resourceId” :
        “IPVPN_NETWORK-af3b9d0a08484e78b624e4bc6860206e”,
        “type” : “NAAS”,
        “operation” : “BUILD”,
        “resourceType” : “IPVPN_NETWORK”,
        “status” : “SUCCESS”,
        “startDate” : “2023-06-10 10:33:55”,
        “endDate” : “2023-06-10 10:36:39”,
        “properties” : {.....}
      },
      {
        “_id” : “2”,
        “type” : “BILLING”,
        “operation” : “BUILD”,
        “resourceType” : “BILLING”,
        “status” : “SUCCESS”,
        “startDate” : “2023-06-10 10:36:39”,
        “endDate” : “2023-06-11 14:03:08”,
        “properties” : {.....}
      }
    ]
  }
]
```

An initial state of a generated transaction may be as shown in the following example template file or example transaction data:

```
“transactions” : [
  {
    “transactionId” : “88aa248b-78af-46d0-beaf-d532518c1094”,
    “action” : “ACTIVATE”,
    “request” : { },
    “startDate” : “2023-06-10 10:33:55”,
    “endDate” : null,
    “status”: “NOT_STARTED”
    “tasks” : [
      {
        “_id” : “1”,
        “resourceId” : null,
        “type” : “NAAS”,
        “operation” : “BUILD”,
        “resourceType” : “IPVPN_NETWORK”,
        “status” : “NOT_STARTED”,
        “startDate” : null,
        “endDate” : null,
        “properties” : {.....}
      },
      {
        “_id” : “2”,
        “type” : “BILLING”,
        “operation” : “BUILD”,
        “resourceType” : “BILLING”,
        “status” : “NOT_STARTED”,
        “startDate” : null,
        “endDate” : null,
        “properties” : {.....}
      }
    ]
  }
]
```

An example data structure for a DyCon or DyCon IPVPN task may be as follows:

```
“tasks” : [
  {
    “_id” : “1”,
    “resourceId” : ‘unique field for NaaS task’,
    “type” : “NAAS” / “LAYER3” / “BILLING”,
    “operation” : “BUILD” / “DELETE”,
    “resourceType” : “IPVPN_NETWORK”,
    “status” : “NOT_STARTED” / “WIP” / “SUCCESS” / “FAILURE”,
    “startDate” : null / ‘start date and time’,
    “endDate” : null / ‘end date and time’,
    “properties” : {
      “isCriticalTask” : true / false,
      “hasDeleteDependency” : true / false,
      “includedInDeleteWorkflow” : true / false,
    }
  },
```

In examples, the task properties, as shown in the example data structure above, may include a first property indicating whether the task is a critical task (e.g., “isCriticalTask” above), a second property indicating whether the task has delete dependency (e.g., “hasDeleteDependency” above), and a third property indicating whether the task has delete dependency (e.g., “includedInDeleteWorkflow” above). The first property is used for determining whether the task will have an impact on the overall state of the IPVPN activate (or build) or disconnect (or delete) processes, where a non-critical task has no impact on the overall state of IPVPN for activate (or build) or disconnect (or delete) processes, while a critical task does have impact on the overall state of IPVPN for activate (or build) or disconnect (or delete) processes. The second property is used to determine timing of triggering of tasks, where tasks without delete dependency can be triggered asynchronously at the beginning (or at other times) of the delete workflow, tasks with delete dependency must be triggered either before or after deletion of a dependent task within the delete workflow. The third property is used to control whether the task should be added to the delete workflow at all.

Transaction factory 325 or first orchestrator 320a requests a first task manager among the plurality of task managers from a task factory 335, based on a task type associated with a first task among one or more DyCon IPVPN tasks associated with the first network provisioning service. The one or more DyCon IPVPN tasks are described in detail above with respect to FIG. 1. In some examples, the plurality of task managers may include a NaaS task manager, a layer 3 task manager, a billing task manager, and/or the like. In some examples, the plurality of task managers represents multiple types of task managers with one or more instances of each type being implemented during operation. Task factory 335 selects and returns the first task manager 340a (where “returning the task manager” is described in detail above with respect to FIG. 1), based on the task type associated with the first task. In some examples, a task type of the first task is the task type on which the request for the first task manager is based. In some cases, the first ordered list of tasks includes the first task among one or more DyCon IPVPN tasks associated with the first network provisioning service or associated with the first product that is associated with the first network provisioning service.

Each task manager of the plurality of task managers is configured to perform at least one of: creating a task (e.g., “createTask( )” in FIG. 3A); triggering execution of the task (e.g., “executeTask( )” in FIG. 3A); updating the task (e.g., “updateTask( )” in FIG. 3A); and/or handling task failure (e.g., “handleTaskFailure( )” in FIG. 3A); and/or the like. Transaction factory 325 or first orchestrator 320a instructs (e.g., as denoted by the double-headed dash-lined arrow and the double-headed solid-lined arrow, respectively, that connect with the first task manager 340a) the first task manager 340a to create the first task (e.g., as denoted by the bold-highlighted “createTask( )” in FIG. 3A). For the IPVPN build process, the first orchestrator 320 determines (at operation 345) whether the first task has not yet started. If the first task has been determined to have started, the build process stops (at operation 350). If the first task has been determined to not have started, the build process and the example sequence flow 300A continues onto example sequence flow 300B in FIG. 3B, following the circular marker denoted, “A.”

Turning to example sequence flow 300B of FIG. 3B (following circular marked denoted, “A,” from FIG. 3A), a second orchestrator 320b requests a second task manager among the plurality of task managers from task factory 335, based on a task type associated with a first task among one or more DyCon IPVPN tasks associated with the first network provisioning service. Task factory 335 selects and returns the second task manager 340b, based on the task type associated with the first task. In an example, the second orchestrator 320b and the first orchestrator 320a are the same orchestrator. In another example, the second orchestrator 320b and the first orchestrator 320a are different orchestrators among the plurality of orchestrators. Herein, different orchestrators either may be different orchestrators among the same type of orchestrators or may be different types of orchestrators entirely. Similarly, in an example, the second task manager 340b and the first task manager 340a are the same task manager. In another example, the second task manager 340b and the first task manager 340a are different task managers among the plurality of task managers. Herein, different task managers either may be different task managers among the same type of task managers or may be different types of task managers entirely. In the case that the first and second task managers are the same task manager and that the first and second orchestrators are the same orchestrator, requesting the second task manager form the task factory 335 may be skipped.

Second orchestrator 320b instructs the second task manager 340b to execute the first task (e.g., as denoted by the bold-highlighted “createTask( )” in FIG. 3B). In executing the first task, the second task manager 340b requests, from a NaaS API factory 355, a first NaaS service system among a plurality of NaaS service systems, based on a first resource type associated with the first task. In examples, the plurality of NaaS service systems may include a NaaS IP service system, a NaaS virtual private cloud (“VPC”) service system, a NaaS IPVPN network service system, a NaaS layer 3 VPN service system, and/or the like. In some examples, the plurality of NaaS service systems represents multiple types of NaaS service systems with one or more instances of each type being implemented during operation. Each task manager instructs a selected NaaS service system 360 to perform one of building a NaaS API associated with the NaaS service system (e.g., “doBuild( )” in FIG. 3B); deleting a NaaS API associated with the NaaS service system (e.g., “doDelete( )” in FIG. 3B); or obtaining a status (e.g., “doGet( )” in FIG. 3B) of building or deleting a NaaS API associated with the NaaS service system; and/or the like. In the example sequence flow 300B of FIG. 3B, after the NaaS API factory 355 returns the first NaaS service system 360 (where “returning the NaaS service system” is described in detail above with respect to FIG. 1), the second task manager 340b instructs the first NaaS service system 360 to build a NaaS API associated with the first NaaS service system (e.g., as denoted by the bold-highlighted “doBuild( )” in FIG. 3B). In some examples, triggering execution of the first task further includes the second task manager 340b instructing, via the NaaS API 365, a downstream system(s) 370 to execute the first task. In some examples, the downstream system(s) 370 sends a callback message, via NaaS API 365, to callback controller 375.

Referring to example sequence flow 300C of FIG. 3C, callback controller 375 requests, from DyCon IPVPN gateway 310, a third orchestrator among the plurality of orchestrators, based on the first product type. The DyCon IPVPN gateway 310, in turn, requests the third orchestrator among the plurality of orchestrators from orchestrator factory 315, and returns the third orchestrator to the callback controller 375. In response to receiving a callback message from the downstream system(s) 370 indicating that the first task has been successfully completed, the callback controller 375 instructs DyCon IPVPN gateway 310 to instruct the third orchestrator 320c to update the first task. In updating the first task, the third orchestrator 320c requests a third task manager among the plurality of task managers from task factory 335, based on a task type associated with a first task among one or more DyCon IPVPN tasks associated with the first network provisioning service. Task factory 335 selects and returns the third task manager 340c, based on the task type associated with the first task. In an example, the third orchestrator 320c and at least one of the second orchestrator 320b or the first orchestrator 320a are the same orchestrator. In another example, the first through third orchestrators 320a-320c are different orchestrators among the plurality of orchestrators. Herein, different orchestrators either may be different orchestrators among the same type of orchestrators or may be different types of orchestrators entirely, or a combination of these. Similarly, in an example, the third task manager 340c and at least one of the second task manager 340b or the first task manager 340a are the same task manager. In another example, the first through third task managers 340a-340c are different task managers among the plurality of task managers. Herein, different task managers either may be different task managers among the same type of task managers or may be different types of task managers entirely, or a combination of these. In the case that the first through third task managers are the same task manager and that the first through third orchestrators are the same orchestrator, requesting the third task manager form the task factory 335 may be skipped.

Third orchestrator 320c instructs the third task manager 340c to update the first task (e.g., as denoted by the bold-highlighted “updateTask( )” in FIG. 3C). In updating the first task, it is determined whether the task status of the first task indicates “Success.” Based on a determination that the task status of the first task indicates “Success,” the callback controller 375 and/or the third task manager 340c returns to the determination at operation 345 in sequence flow 300A in FIG. 3A, following the circular marker denoted, “B,” where the build process either stops (at operation 350) or repeats through sequence flows 300B and 300C in FIGS. 3B and 3C. Based on a determination that the task status of the first task indicates “Failure” and the first task is a critical build task, the third orchestrator 320c and/or the third task manager 340c initiates a rollback process and updates an IPVPN state to reflect activation failure. Herein, the “rollback process” refers to a process of returning to a previous state, in this case, returning network resources to a previous state and/or returning a database or network resources inventory to a previous state. Based on a determination that the task status of the first task indicates “Failure” and the first task is a non-critical build task, the callback controller 375 and/or the third task manager 340c proceeds with a next task among the one or more DyCon IPVPN tasks, in some cases, by returning to the build process in sequence flow 300A in FIG. 3A, following the circular marker denoted, “C.”

Although the first task is described and shown in FIG. 3 as being a build task, this is merely for purposes of illustration, and the other DyCon IPVPN tasks (as described above) may be implemented in a similar manner, with each task in an ordered list of tasks being cycled through the sequence flows 300A-300C of FIGS. 3A-3C. For instance, although not shown in FIG. 3, a delete task may be implemented instead. With reference to operation 380 for a delete task, Based on a determination that the task status of the delete task indicates “Success,” the callback controller 375 and/or the third task manager 340c returns to the determination at operation 345 in sequence flow 300A in FIG. 3A, following the circular marker denoted, “B,” where the delete process either stops (instead of the build process at operation 350) or repeats through sequence flows 300B and 300C in FIGS. 3B and 3C. Based on a determination that the task status of the first task indicates “Failure” and the first task is a critical delete task, the third orchestrator 320c and/or the third task manager 340c stops the delete process (and in some cases, initiates a rollback process) and updates the IPVPN state to reflect disconnection failure. Based on a determination that the task status of the first task indicates “Failure” and the first task is a non-critical delete task, the callback controller 375 and/or the third task manager 340c proceeds with a next task among the one or more DyCon IPVPN tasks, in some cases, by returning to the process in sequence flow 300A in FIG. 3A, following the circular marker denoted, “C,” for the delete process (instead of the build process).

In some examples, the callback controller 375 may be further configured to perform an update function including at least one of finding a database record matching a product instance identifier (“ID”) of a first product associated with the first task; finding a transaction within a service data transfer object (“DTO”) model matching a transaction ID of a transaction associated with the first product and the first task; finding a task with the transaction matching a task ID and a task type of the first task; calling a task manager among the plurality of task managers to update a task status of the first task; updating the first transaction; or updating the first network provisioning service; and/or the like.

In an aspect, for a build workflow, an IPVPN orchestrator generates a transaction with a series of tasks based on a product template, calls a function for proceeding to a next task to start the task with a status of “NOT_STARTED,” and obtains (e.g., retrieves or gets) a task manager based on a task type (e.g., a NaaS task manager for a task type of NaaS, a billing task manager for a task type of billing, etc.). Each task manager is responsible for performing some specific tasks (e.g., build, delete, update, etc.). The IPVPN orchestrator calls a task manager's execute task function to trigger execution of the task. Each task manager calls its own collaborators to orchestrate a payload and to send the payload downstream. In an example, a NaaS task manager calls NaaS payload service to create a NaaS API FQM, then calls a NaaS API service to send out a POST or DELETE request. In another example, a billing task manager calls a billing payload service to create a billing API FQM, then calls a billing API service to send out a PUT request. In examples, each build workflow follows the following pattern: DyCon IPVPN controller to DyCon IPVPN gateway (or façade) to IPVPN orchestrator to DyCon task manager to collaborator services (e.g., downstream system(s), etc.). In some instances, each of these components is configured to follow a single-responsibility principle, in which each of these components is tasked with only one job.

For a delete workflow, an IPVPN orchestrator generates a transaction with a series of tasks based on an activate (or build) transaction. Tasks in the delete transaction is in the reverse order of tasks in the activate (or build) transaction. The task's property “includedInDeleteWorkflow” determines whether a task should be included in the delete transaction or not. Tasks with no delete dependencies are triggered asynchronously. The remaining tasks are triggered in order. As with the build workflow, the IPVPN orchestrator obtains (e.g., retrieves or gets) a task manager based on a task type (e.g., a NaaS task manager for a task type of NaaS, a billing task manager for a task type of billing, etc.), and each task manager is responsible for performing some specific tasks (e.g., build, delete, update, etc.). The IPVPN orchestrator calls the task manager's “executeTask” function to trigger the task. In some examples, the “executeTask” function is annotated as “@Async,” indicating asynchronous execution. In examples, each delete workflow (like the build workflow) follows the following pattern: DyCon IPVPN controller to DyCon IPVPN gateway (or façade) to IPVPN orchestrator to DyCon task manager to collaborator services (e.g., downstream system(s), etc.). As above, each of these components is configured to follow a single-responsibility principle, in which each of these components is tasked with only one job.

For a callback workflow, in examples, the DyCon IPVPN system or API relies on the downstream system(s) to make callbacks (or send callback messages), rather than polling the downstream system(s). In an example, one generic callback endpoint in the callback controller handles callback from a NaaS API and/or a billing API. In some examples, a callback endpoint may be defined as follows:

```
POST:
/products/{productInstanceId}/transactions/{transactionId}?productType=
  <productType>&taskType=<taskType>&taskId=<taskId>
Payload:
  {
    “source”: “NAAS” / “BILLING” / “LAYER3”,
    “resourceId”: “downstream resource id”,
    “requestId”: “optional”,
    “status”: “SUCCESS” / “FAILURE”,
    “operation”: “BUILD” / “DELETE”,
    “links”: {
      “self”: {
        “href”: “downstream GET endpoint link”
          }
      }
  }
```

The IPVPN orchestrator has an update function that handles the callback, as follows: (a) it finds a database record matching the product instance ID; (b) it finds a transaction within a service DTO matching the transaction ID; (c) it finds a task within the transaction matching the task ID and task type; (d) based on the task type, it calls a specific task manager's “updateTask” function to update a task status; (e) it updates the transaction; (f) it updates the service; and (g) it calls a “proceedToNextTask” function to start a next available task if the current task status indicates “SUCCESS.” For a fallout in an activate process, if a task is a critical task and its status indicates “FAILURE,” a rollback process is initiated and the IPVPN state is updated to reflect the activation failure. If a task is a non-critical task and its status indicates “FAILURE,” the IPVPN state is not impacted and the build process is continued. For a fallout in a disconnect process, if a task is a critical task and its status indicates “FAILURE,” the delete process is stopped and the IPVPN state is updated to reflect the disconnect failure. If a task is a non-critical task and its status indicates “FAILURE,” the IPVPN state is not impacted and the delete process is continued. In examples, statuses of only critical tasks have impact on whether the build or delete process should continue.

These and other functions of the examples 300A, 300B, and 300C (and their components) are described in greater detail herein with respect to FIGS. 1, 2, and 4.

FIGS. 4A and 4B (collectively, “FIG. 4”) depict various example methods 400A and 400B for implementing DyCon IPVPN functionalities, in accordance with various embodiments. While the techniques and procedures are depicted and/or described in a certain order for purposes of illustration, it should be appreciated that certain procedures may be reordered and/or omitted within the scope of various embodiments. Moreover, while the methods 400A and 400B illustrated by FIGS. 4A and 4B can be implemented by or with (and, in some cases, are described below with respect to) the systems, examples, or embodiments 100, 200A, 200B, 300A, 300B, and 300C of FIGS. 1, 2A, 2B, 3A, 3B, and 3C, respectively (or components thereof), such methods may also be implemented using any suitable hardware (or software) implementation. Similarly, while each of the systems, examples, or embodiments 100, 200A, 200B, 300A, 300B, and 300C of FIGS. 1, 2A, 2B, 3A, 3B, and 3C, respectively (or components thereof), can operate according to the methods 400A and 400B illustrated by FIGS. 4A and 4B (e.g., by executing instructions embodied on a computer readable medium), the systems, examples, or embodiments 100, 200A, 200B, 300A, 300B, and 300C of FIGS. 1, 2A, 2B, 3A, 3B, and 3C can each also operate according to other modes of operation and/or perform other suitable procedures.

In the non-limiting embodiment of FIG. 4A, method 400A, at operation 405, may include receiving, by a computing system, a request to build an IPVPN. In some examples, the computing system includes at least one of a DyCon IPVPN system, a DyCon IPVPN controller, a DyCon IPVPN gateway device, a DyCon IPVPN orchestrator, a NaaS workflow engine, a server, a cloud computing system, or a distributed computing system, and/or the like. At operation 410, method 400A may include requesting, by the computing system and from an orchestrator factory, a first orchestrator among a plurality of orchestrators based on a first product type that is associated with the IPVPN in the request. At operation 415, method 400A may include instructing, by the computing system, the first orchestrator to orchestrate building of the IPVPN, by the first orchestrator requesting a first task manager among a plurality of task managers from a task factory based on a task type associated with a task of building the IPVPN (at operation 420); and the first orchestrator instructing the first task manager to build, or to cause building of, the IPVPN (at operation 425).

According to some embodiments, instructing the first orchestrator to orchestrate building of the IPVPN (at operation 415) further includes instructing, by the computing system, the first orchestrator to request first transaction data among a plurality of transaction data from a transaction factory based on the first product type (at operation 430). In some examples, the first transaction data includes a first ordered list of tasks for the first product type. In some cases, the first ordered list of tasks includes the first task among the one or more DyCon IPVPN tasks. In some instances, a task type of the first task is the task type on which the request for the first task manager is based. In examples, the transaction factory generates a first template file associated with the first product type that is related to building IPVPNs and sends the first template file as the first transaction data to the first orchestrator, the first template file including an ordered list of tasks for building IPVPNs. In some examples, the transaction factory accesses one or more template files associated with a plurality of product types, the one or more template files, including an ordered list of tasks for each product type. In some cases, the transaction factory determines, from a first template file among the one or more template files, the first transaction data, including the first ordered list of tasks, and sends the first transaction data, including the first ordered list of tasks, to the first orchestrator.

In some embodiments, building of the IPVPN follows a first ordered list of tasks in which the tasks are performed in a first order. In some examples, method 400A further includes, at operation 435, receiving, by the computing system, a request to delete the IPVPN. At operation 440, method 400A further includes, in response to receiving the request to delete the IPVPN, instructing, by the computing system, the first orchestrator to orchestrate deleting of the IPVPN, by the first orchestrator instructing the first task manager to delete, or to cause deletion of, the IPVPN, by implementing a delete workflow based on a second ordered list of tasks (at operation 445); and the first orchestrator instructing each downstream system to return a callback message to a callback system indicating when each delete task that is handled by said downstream system has been successfully completed or has failed (at operation 450).

In some cases, delete tasks in the second ordered list of tasks correspond to build tasks in the first ordered list that are labelled in the first transaction data or the first template file as being included in the delete workflow. In some instances, the second ordered list of tasks includes delete tasks for deleting the IPVPN in a second order that is a reverse of the first order except that delete tasks corresponding to build tasks in the first ordered list that are labelled in the first transaction data or the first template file as not having delete dependency are triggered asynchronously at a beginning of the delete workflow.

Referring to the non-limiting example of FIG. 4B, method 400B, at operation 455, may include receiving, by a task manager of a system and from an orchestrator of the system, a request to perform a first task among one or more DyCon IPVPN tasks. In some embodiments, the system includes at least one of a DyCon IPVPN system, a NaaS workflow engine, a server, a cloud computing system, or a distributed computing system, and/or the like. At operation 460, method 400B may include performing, by the task manager, at least one of creating the first task (at operation 465a); triggering execution of the first task (at operation 465b); updating the first task (at operation 465c); or handling one or more task failures associated with implementing the first task (at operation 465d); and/or the like. In some instances, the plurality of NaaS service systems includes at least one a NaaS IP service system, a NaaS VPC service system, a NaaS IPVPN network service system, or a NaaS layer 3 VPN service system, and/or the like. In some cases, triggering execution of the first task includes instructing, by the task manager and via the NaaS API, a downstream system to execute the first task.

According to some embodiments, the one or more DyCon IPVPN tasks includes at least one of one or more virtual routing and forwarding (“VRF”) tasks; one or more NaaS IPVPN tasks; one or more NaaS API framework for queue management (“FQM”) tasks; one or more layer 3 VPN tasks; one or more layer 3 VPN API FQM tasks; one or more billing tasks; one or more billing API FQM tasks; or one or more inventory tasks; and/or the like. In some instances, the one or more VRF tasks include at least one of building a VRF instance; deleting a VRF instance; or updating a VRF instance; and/or the like. In some cases, the one or more NaaS IPVPN tasks include at least one of building a NaaS IPVPN network; deleting a NaaS IPVPN network; or updating a NaaS IPVPN network; and/or the like. In some examples, the one or more NaaS API FQM tasks include at least one of creating a NaaS API FQM; or deleting a NaaS API FQM; and/or the like. In examples, the one or more layer 3 VPN tasks include at least one of building a layer 3 VPN network; deleting a layer 3 VPN network; or updating a layer 3 VPN network; and/or the like. In some instances, the one or more layer 3 VPN API FQM tasks includes at least one of creating a layer 3 VPN API FQM; or deleting a layer 3 VPN API FQM; and/or the like. In some cases, the one or more billing tasks include at least one of building a billing record; deleting a billing record; or updating a billing record; and/or. In some examples, the one or more billing API FQM tasks include at least one of creating a billing API FQM; or deleting a billing API FQM; and/or the like. In examples, the one or more inventory tasks include at least one of updating a network resource inventory; or auditing a network resource inventory; and/or the like.

At operation 470, method 400B may include requesting, by the task manager and from a NaaS API factory, a first NaaS service system among a plurality of NaaS service systems based on a first resource type associated with the first task. At operation 475, method 400B may include instructing, by the task manager, the first NaaS service system to perform one of building a NaaS API associated with the first NaaS service system (at operation 480a); deleting a NaaS API associated with the first NaaS service system (at operation 480a); or obtaining a status of building or deleting a NaaS API associated with the first NaaS service system (at operation 480c); and/or the like.

### Exemplary System and Hardware Implementation

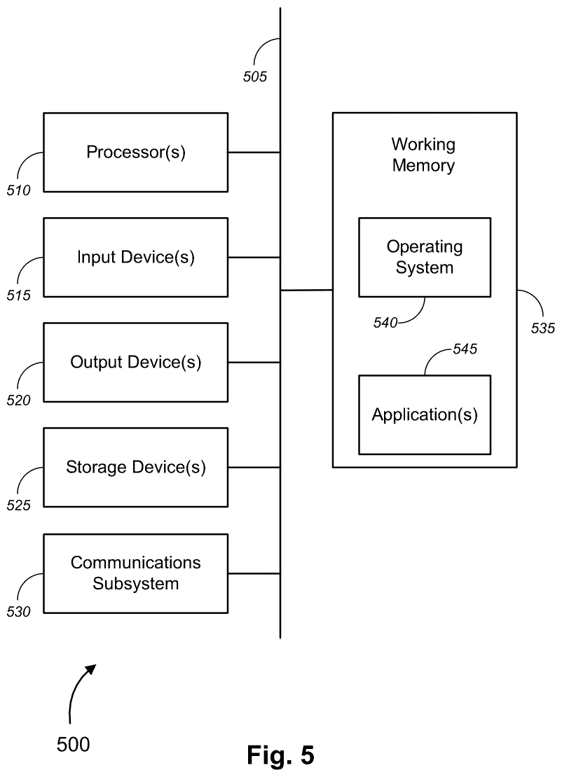

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a-1051, DyCon IPVPN system 120, controller 120a, gateway device 120b, callback controller 120c, orchestrators 125a-125v, task managers 135-135x, and NaaS service systems 140a-140y, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a-1051, DyCon IPVPN system 120, controller 120a, gateway device 120b, callback controller 120c, orchestrators 125a-125v, task managers 135-135x, and NaaS service systems 140a-140y, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A dynamic connections (“DyCon”) Internet Protocol virtual private network (“IPVPN”) system, comprising:
a gateway device configured to:
request a first orchestrator among a plurality of orchestrators from an orchestrator factory based on data contained in a request to perform a first network provisioning service among a plurality of network provisioning services; and
instruct the first orchestrator to perform the first network provisioning service;
the plurality of orchestrators, each orchestrator being configured to:
request a first task manager among a plurality of task managers from a task factory based on a task type associated with a first task among one or more DyCon IPVPN tasks associated with the first network provisioning service; and
instruct the first task manager to perform the first task; and
the plurality of task managers, each task manager being configured to perform at least one of:
creating the first task;
triggering execution of the first task; or
updating the first task.

2. The system of claim 1, wherein the data contained in the request comprises a first product type among a plurality of product types, the first product type being associated with the first network provisioning service, wherein each orchestrator is further configured to:
request first transaction data among a plurality of transaction data from a transaction factory based on the first product type;
wherein the first transaction data includes a first ordered list of tasks for the first product type, wherein the first ordered list of tasks includes the first task among the one or more DyCon IPVPN tasks, wherein a task type of the first task is the task type on which the request for the first task manager is based.

3. The system of claim 2, wherein the system further comprises:
a controller configured to trigger one or more DyCon IPVPN functionalities in response to receiving the request to perform the first network provisioning service;
the orchestrator factory configured to select and return the first orchestrator among the plurality of orchestrators based on the first product type associated with the first network provisioning service;
the transaction factory configured to perform one of:
accessing one or more template files associated with the plurality of product types, the one or more template files including an ordered list of tasks for each product type; determining, from a first template file among the one or more template files, the first transaction data, including the first ordered list of tasks; and sending the first transaction data, including the first ordered list of tasks, to the first orchestrator; or
determining the first transaction data, including the first ordered list of tasks, based on the product type; generating the first template file based on the determination; and sending the first template file as the first transaction data, including the first ordered list of tasks, to the first orchestrator; and
the task factory configured to select and return the first task manager based on the task type associated with the first task.

4. The system of claim 3, wherein the one or more DyCon IPVPN tasks comprise at least one of:
one or more virtual routing and forwarding (“VRF”) tasks including at least one of:
building a VRF instance;
deleting a VRF instance; or
updating a VRF instance;
one or more network as a service (“NaaS”) IPVPN tasks including at least one of:
building a NaaS IPVPN network;
deleting a NaaS IPVPN network; or
updating a NaaS IPVPN network;
one or more NaaS API framework for queue management (“FQM”) tasks including at least one of:
creating a NaaS API FQM; or
deleting a NaaS API FQM;
one or more layer 3 VPN tasks including at least one of:
building a layer 3 VPN network;
deleting a layer 3 VPN network; or
updating a layer 3 VPN network;
one or more layer 3 VPN API FQM tasks including at least one of:
creating a layer 3 VPN API FQM; or
deleting a layer 3 VPN API FQM;
one or more billing tasks including at least one of:
building a billing record;
deleting a billing record;
updating a billing record;
one or more billing API FQM tasks including at least one of:
creating a billing API FQM; or
deleting a billing API FQM; or
one or more inventory tasks including at least one of:
updating a network resource inventory; or
auditing a network resource inventory.

5. The system of claim 2, wherein each task manager is further configured to perform at least one of:
handling one or more task failures associated with implementing the first task;
requesting a first NaaS service system among a plurality of NaaS service systems from a NaaS API factory based on a first resource type associated with the first task; or
instructing the first NaaS service system to perform one of:
building a NaaS API associated with the first NaaS service system;
deleting a NaaS API associated with the first NaaS service system: or
obtaining a status of building or deleting a NaaS API associated with the first NaaS service system;
wherein the plurality of NaaS service systems comprises at least one a NaaS IP service system, a NaaS virtual private cloud (“VPC”) service system, a NaaS IPVPN network service system, or a NaaS layer 3 VPN service system;
wherein triggering execution of the first task comprises instructing, via the NaaS API, a downstream system to execute the first task.

6. The system of claim 5, further comprising:
a callback controller configured to:
receive a callback message from the downstream system indicating that the first task has been successfully completed;
request a second orchestrator among the plurality of orchestrators to perform one of a second task among the one or more DyCon IPVPN tasks associated with the first network provisioning service or a second network provisioning service among the plurality of network provisioning services; and
instruct the second orchestrator to perform the one of the second task or the second network provisioning service.

7. The system of claim 6, wherein the callback controller is further configured to:
perform an update function including at least one of:
finding a database record matching a product instance identifier (“ID”) of a first product associated with the first task;
finding a transaction within a service data transfer object (“DTO”) model matching a transaction ID of a transaction associated with the first product and the first task;
finding a task with the transaction matching a task ID and a task type of the first task;
calling a task manager among the plurality of task managers to update a task status of the first task;
updating the first transaction; or
updating the first network provisioning service;
based on a determination that a task status of the first task is success, initiate implementation of a next task in the first ordered list of tasks;
based on a determination that the first task is a critical build task and that the task status of the first task is failure, initiating a rollback process and updating an IPVPN state to reflect activation failure;
based on a determination that the first task is a non-critical build task and that the task status of the first task is failure, proceed with a next task among the one or more DyCon IPVPN tasks;
based on a determination that the first task is a critical delete task and that the task status of the first task is failure, stopping process of deletion and updating the IPVPN state to reflect disconnection failure;
based on a determination that the first task is a non-critical delete task and that the task status of the first task is failure, proceed with the next task among the one or more DyCon IPVPN tasks.

8. The system of claim 1, wherein:
the plurality of orchestrators comprises at least one of an IPVPN service orchestrator, an IPVPN network orchestrator, or a DyCon IPVPN orchestrator; and
the plurality of task managers comprises at least one of a NaaS task manager, a billing task manager, or a DyCon IPVPN task manager.

9. The system of claim 1, wherein the request is included in user input that is received from a user device via an a DyCon IPVPN API.

10. The system of claim 1, wherein the DyCon IPVPN system is implemented within one or more virtual machines (“VMs”).

11. A method, comprising:
in response to receiving a request to build an Internet Protocol virtual private network (“IPVPN”), requesting, by a computing system and from an orchestrator factory, a first orchestrator among a plurality of orchestrators based on a first product type that is associated with the IPVPN in the request; and
instructing, by the computing system, the first orchestrator to orchestrate building of the IPVPN, by:
requesting a first task manager among a plurality of task managers from a task factory based on a task type associated with a task of building the IPVPN; and
instructing the first task manager to build, or to cause building of, the IPVPN.

12. The method of claim 11, wherein the computing system comprises at least one of a dynamic connections (“DyCon”) IPVPN system, a DyCon IPVPN controller, a DyCon IPVPN gateway device, a DyCon IPVPN orchestrator, a NaaS workflow engine, a server, a cloud computing system, or a distributed computing system.

13. The method of claim 11, wherein instructing the first orchestrator to orchestrate building of the IPVPN further includes:
instructing, by the computing system, the first orchestrator to request first transaction data among a plurality of transaction data from a transaction factory based on the first product type;
wherein the first transaction data includes a first ordered list of tasks for the first product type, wherein the first ordered list of tasks includes the first task among the one or more DyCon IPVPN tasks, wherein a task type of the first task is the task type on which the request for the first task manager is based.

14. The method of claim 13, wherein the transaction factory generates a first template file associated with the first product type that is related to building IPVPNs and sends the first template file as the first transaction data to the first orchestrator, the first template file including an ordered list of tasks for building IPVPNs.

15. The method of claim 13, wherein the transaction factory accesses one or more template files associated with a plurality of product types, the one or more template files including an ordered list of tasks for each product type, wherein the transaction factory determines, from a first template file among the one or more template files, the first transaction data, including the first ordered list of tasks, and sends the first transaction data, including the first ordered list of tasks, to the first orchestrator.

16. The method of claim 13, wherein building of the IPVPN follows a first ordered list of tasks in which the tasks are performed in a first order, wherein the method further comprises:
in response to receiving a request to delete the IPVPN, instructing, by the computing system, the first orchestrator to orchestrate deleting of the IPVPN, by:
instructing the first task manager to delete, or to cause deletion of, the IPVPN, by implementing a delete workflow based on a second ordered list of tasks, wherein delete tasks in the second ordered list of tasks correspond to build tasks in the first ordered list that are labelled in the first transaction data or the first template file as being included in the delete workflow, wherein the second ordered list of tasks includes delete tasks for deleting the IPVPN in a second order that is a reverse of the first order except that delete tasks corresponding to build tasks in the first ordered list that are labelled in the first transaction data or the first template file as not having delete dependency are triggered asynchronously at a beginning of the delete workflow; and
instructing each downstream system to return a callback message to a callback system indicating when each delete task that is handled by said downstream system has been successfully completed or has failed.

17. A method, comprising:
receiving, by a task manager of a system and from an orchestrator of the system, a request to perform a first task among one or more dynamic connections (“DyCon”) Internet Protocol virtual private network (“IPVPN”) tasks; and
performing, by the task manager, the following:
creating the first task;
triggering execution of the first task; and
updating the first task;
wherein triggering execution of the first task, after creating the first task, comprises:
requesting, by the task manager and from a NaaS application programming interface (“API”) factory, a first NaaS service system among a plurality of NaaS service systems based on a first resource type associated with the first task; and
instructing, by the task manager, the first NaaS service system to perform one of:
building a NaaS API associated with the first NaaS service system;
deleting a NaaS API associated with the first NaaS service system; or
obtaining a status of building or deleting a NaaS API associated with the first NaaS service system.

18. The method of claim 17, wherein the system comprises at least one of a DyCon IPVPN system, a network as a service (“NaaS”) workflow engine, a server, a cloud computing system, or a distributed computing system.

19. The method of claim 17, further comprising:
handling, by the task manager, one or more task failures associated with implementing the first task;
wherein the plurality of NaaS service systems comprises at least one a NaaS IP service system, a NaaS VPC service system, a NaaS IPVPN network service system, or a NaaS layer 3 VPN service system;
wherein triggering execution of the first task further comprises instructing, by the task manager and via the NaaS API, a downstream system to execute the first task;
wherein updating the first task comprises updating the first task based on callback information from the downstream system regarding whether or not execution of the first task was successful.

20. The method of claim 17, wherein the one or more DyCon IPVPN tasks comprise at least one of:
one or more virtual routing and forwarding (“VRF”) tasks including at least one of:
building a VRF instance;
deleting a VRF instance; or
updating a VRF instance;
one or more network as a service (“NaaS”) IPVPN tasks including at least one of:
building a NaaS IPVPN network;
deleting a NaaS IPVPN network; or
updating a NaaS IPVPN network;
one or more NaaS API framework for queue management (“FQM”) tasks including at least one of:
creating a NaaS API framework for queue management (“FQM”); or
deleting a NaaS API FQM;
one or more layer 3 VPN tasks including at least one of:
building a layer 3 VPN network;
deleting a layer 3 VPN network; or
updating a layer 3 VPN network;
one or more layer 3 VPN API FQM tasks including at least one of:
creating a layer 3 VPN API FQM; or
deleting a layer 3 VPN API FQM;
one or more billing tasks including at least one of:
building a billing record;
deleting a billing record;
updating a billing record;
one or more billing API FQM tasks including at least one of:
creating a billing API FQM; or
deleting a billing API FQM; or
one or more inventory tasks including at least one of:
updating a network resource inventory; or
auditing a network resource inventory.
